(19) United States
(12) Patent Application Publication
(10) Pub. No.: US 2009/0280388 A1
(43) Pub. Date: Nov. 12, 2009

(54) FUEL CELL

(75) Inventors: Toshiyuki Inagaki, Aichi (JP); Akihiko Takami, Aichi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/305,168

(22) PCT Filed: Jun. 18, 2007
(86) PCT No.: PCT/JP2007/062648

§ 371 Date: Dec. 16, 2008

(30) Foreign Application Priority Data
Jun. 20, 2006 (JP) 2006-170522

(51) Int. Cl. H01M 2/02

(52) U.S. Cl. 429/34

(57) ABSTRACT

A fuel cell is provided with an end plate arranged outside a cell laminate in the laminating direction of the cell laminate. The fuel cell is also provided with pressing device, arranged on the side of the end plate of the cell laminate, for adjusting a compressive load to be applied to the cell laminate by a load adjusting screw which moves along the laminating direction of the cell laminate against the end plate. Engaging portions of the load adjusting screw and the pressing device are movably arranged in the diameter direction of the load adjusting screw against at least one of the end plate and the pressing device.

### TECHNICAL FIELD

The present invention relates to a fuel cell. More particularly, it relates to a technology effective for improving the assembly precision of the fuel cell.

### BACKGROUND ART

In recent years, much attention has been paid to a fuel cell car or the like using, as an energy source, a fuel cell which generates power by an electrochemical reaction between a fuel gas and an oxidizing gas.

Such a fuel cell is usually constituted as a fuel cell stack including a cell laminate in which the required number of cells for generating the power by the electrochemical reaction between the fuel gas and the oxidizing gas, an end plate arranged outside this cell laminate in a laminating direction thereof, a load adjusting screw movable along the laminating direction of the cell laminate against this end plate, and pressing device (a spring box, a dish spring, a pressure plate or the like) in which a compressive load to be imparted to the cell laminate is adjusted by the load adjusting screw.

The fuel cell having such a stack structure sometimes includes a structure in which the end plate is provided with a polygonal through hole, and the load adjusting screw is engaged with a rotation regulating member to be fitted into this through hole, thereby regulating the rotation (e.g., see Japanese Patent Application Laid-Open No. 8-171926).

### DISCLOSURE OF THE INVENTION

In addition, in a fuel cell, a load adjusting screw and pressing device are sometimes provided with engaging portions positioned in the diameter direction of the load adjusting screw to be engaged with each other. However, in such a cell laminate, a positional relation between the end plate and the pressing device in the diameter direction of the load adjusting screw is determined by the engagement of the engaging portions. Therefore, when a manufacturing error or the like is generated, it is substantially difficult to position the end plate and the pressing device in the diameter direction of the load adjusting screw, that is, a direction (a cell in-plane direction) crossing the laminating direction of a cell laminate at right angles.

To solve the problem, an object of the present invention is to provide a fuel cell in which an end plate and pressing device can be positioned in a direction crossing the laminating direction of a cell laminate at right angles.

To achieve the above object, a fuel cell of the present invention is a fuel cell comprising: a cell laminate in which a plurality of cells are laminated; an end plate arranged outside the cell laminate in the laminating direction of the cell laminate; a load adjusting screw which moves along the laminating direction of the cell laminate against the end plate; and pressing device, arranged on the side of the end plate of the cell laminate, for adjusting a compressive load to be imparted to the cell laminate by the load adjusting screw, wherein engaging portions of the load adjusting screw and the pressing device positioned in the diameter direction of the load adjusting screw to be engaged with each other are movably arranged in the diameter direction of the load adjusting screw against at least one of the end plate and the pressing device.

According to such a constitution, when the engaging portions of the load adjusting screw and the pressing device positioned to be engaged with each other are moved along the diameter direction of the load adjusting screw against at least one of the end plate and the pressing device, the end plate and the pressing device can be positioned in the diameter direction of the load adjusting screw, that is, a direction crossing the laminating direction of the cell laminate at right angles.

In this case, it is preferable to provide an interposed member which is movable in the diameter direction of the load adjusting screw against at least one of the end plate and the pressing device and whose rotation is regulated as much as 360 degrees or more.

Moreover, in a case where a plurality of load adjusting screws are provided, engaging portions of the load adjusting screws and the pressing device are preferably movably provided in the diameter direction of the load adjusting screws against at least one of the end plate and the pressing device.

Furthermore, the pressing device preferably has a recess portion or a protruding portion as the engaging portion.

According to the present invention, the engaging portions of the load adjusting screw and the pressing device positioned in the diameter direction of the load adjusting screw to be engaged with each other are movable in the diameter direction of the load adjusting screw against at least one of the end plate and the pressing device, so that the end plate and the pressing device can be positioned in the diameter direction of the load adjusting screw, that is, the direction crossing the laminating direction of the cell laminate at right angles, and assembly precision can be improved.

### BRIEF DESCRIPTION OF THE DRAWINGS

FIG. 1 is a front sectional view showing a first embodiment of a fuel cell according to the present invention;

FIG. 2 is a plan view showing a stopper, an end plate and a load adjusting screw of the embodiment; and

FIG. 3 is a partially front sectional view showing a second embodiment of the fuel cell according to the present invention.

### BEST MODE FOR CARRYING OUT THE INVENTION

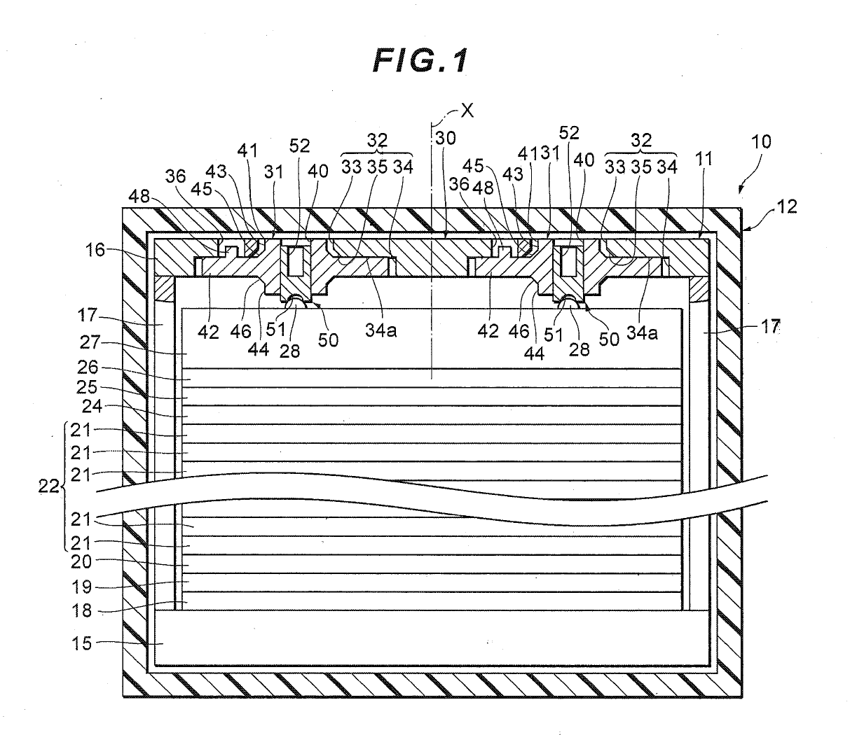

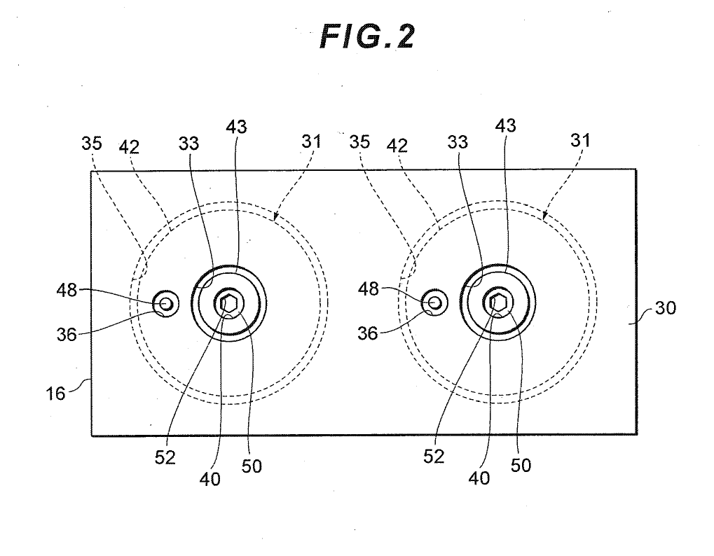

Next, a first embodiment of a fuel cell according to the present invention will be described with reference to FIGS. 1 and 2.

FIG. 1 shows a fuel cell 10. This fuel cell 10 is applicable to a car-mounted power generation system of a fuel cell car, a power generation system for any type of mobile body such as a ship, an airplane, a train or a walking robot, a stational power generation system for use as power generation equipment for construction (housing, building or the like) or the like, but specifically the cell is used for a car.

The fuel cell 10 has a fuel cell stack 11 and a stack case 12 which covers the outer side of this fuel cell stack 11 and which is made of an insulating material such as a synthetic resin. It is to be noted that the stack case 12 is sometimes made of a metal covered with an insulating material such as the synthetic resin.

The outer part of the fuel cell stack 11 is constituted by connecting the outer edges of a pair of rectangular end plates 15, 16 to each other via tension plates 17, and these end plates 15, 16 and the tension plates 17 are made of, for example, duralumin or the like.

Moreover, in the fuel cell stack 11, on the other end plate 16 side of one end plate 15, a rectangular insulating plate 18, a terminal plate 19 and a cover plate 20 are arranged in order from the one end plate 15 side. On the other end plate 16 side of this cover plate 20, a cell laminate 22 in which the required number of cells 21 having a rectangular shape as viewed along a plane and receiving the supply of a fuel gas and an oxidizing gas to generate power are laminated so that the laminating direction of the cells 21 is a direction connecting the end plates 15, 16 to each other.

Furthermore, in the fuel cell stack 11, on the other end plate 16 side of the cell laminate 22, a rectangular cover plate 24, a terminal plate 25 and an insulating plate 26 are arranged in order from the cell laminate 22 side. On the other end plate 16 side of this insulating plate 26, a rectangular spring box (pressing device) 27 as viewed along the plane is arranged.

The spring box 27 is provided with a plurality of coil springs (not shown), so that the insulating plate 26, that is, the cell laminate 22 is pressed in the laminating direction via these coil springs. Moreover, a plurality of predetermined portions, specifically two positions of the spring box 27 are provided with protruding portions (engaging portions) 28 having a spherical shape and protruding on a side opposite to the cell laminate 22. These protruding portions 28 are arranged at predetermined intervals in the length direction of the spring box 27.

Moreover, in the first embodiment, as also shown in FIG. 2, the above other end plate 16 is constituted of a rectangular end plate main body 30 connected to the tension plates 17, and the predetermined number of, specifically two stoppers (interposed members) 31 provided in regions on the inner sides from connecting positions between the end plate main body 30 and the tension plates 17.

The end plate main body 30 is provided with a plurality of through holes 32 extending through the main body at predetermined intervals in a thickness direction. These through holes 32, 32 have the same shape. Each of the through holes has an insertion hole portion 33 disposed on a side opposite to the spring box 27 and having a circular shape as viewed from the side opposite to the spring box 27; a counter hole portion 34 disposed on the spring box 27 side, having a diameter larger than that of the insertion hole portion 33 and recessed with a constant depth so as to have a circular shape as viewed from the spring box 27 side; and a tapered hole portion 35 disposed in a boundary position between the insertion hole portion 33 and the counter hole portion 34 and having such a tapered shape that the tapered hole portion has a larger diameter on the counter hole portion 34 side. The insertion hole portion 33, the counter hole portion 34 and the tapered hole portion 35 constituting the same through hole 32 are disposed along the same axis.

Moreover, in the end plate main body 30, a bottom surface 34a of the counter hole portion 34 of each of the through holes 32, 32 is provided with a rotation regulating hole portion 36 parallel to the insertion hole portion 33. Here, each rotation regulating hole portion 36 has a circular shape as viewed from an axial direction, and both the rotation regulating hole portions are formed along straight lines extending through the centers of the insertion hole portions 33, 33.

A plurality of stoppers 31, 31 have the same shape, and each of the stoppers has a cylindrical boss portion 41 in which an internal thread 40 is formed, and a substantially disc-like flange portion 42 which extends externally in a radial direction from the intermediate position of this boss portion 41 in the axial direction to the whole periphery. Since the flange portion 42 is formed in the intermediate position of the axial direction, the boss portion 41 has a cylindrical portion 43 protruding from one side of the flange portion 42 in the axial direction and a cylindrical portion 44 protruding from the opposite side of the flange portion 42 in the axial direction.

Moreover, in the stopper 31, a tapered portion 45 having a larger diameter on a flange portion 42 side is formed in a boundary position between one side of the flange portion 42 in the axial direction and the cylindrical portion 43 protruding from this side, and a tapered portion 46 having a larger diameter on the flange portion 42 side is formed in a boundary position between the opposite side of the flange portion 42 in the axial direction and the cylindrical portion 44 protruding from this side. The boss portion 41, the flange portion 42, the tapered portion 45 and the tapered portion 46 constituting the same stopper 31 are disposed along the same axis. Here, ribs may be formed radially from the cylindrical portion 44 to reinforce the flange portion 42.

Furthermore, the stopper 31 is provided with a columnar rotation regulating pin portion 48 protruding from the flange portion 42 to the cylindrical portion 43 side in the axial direction in parallel with this cylindrical portion. A distance between the center of the boss portion 41 and the center of the rotation regulating pin portion 48 is equal to a distance between the center of the through hole 32 and the center of the rotation regulating hole portion 36 in the end plate main body 30.

Such stoppers 31, 31 are inserted into the end plate main body 30, respectively. While one cylindrical portion 43 of the boss portion 41 is inserted into the insertion hole portion 33, the tapered portion 45 is inserted into the tapered hole portion 35 and the flange portion 42 is inserted into the counter hole portion 34, the rotation regulating pin portion 48 is inserted into the rotation regulating hole portion 36, whereby the flange portion 42 is allowed to abut on the bottom surface 34a of the counter hole portion 34. At this time, the insertion hole portion 33 has a diameter larger than that of the cylindrical portion 43, the counter hole portion 34 has a diameter larger than that of the flange portion 42 and the rotation regulating hole portion 36 has a diameter larger than that of the rotation regulating pin portion 48.

In consequence, the stopper 31 has such play that the stopper is movable along the diameter direction of the internal thread 40, that is, the diameter direction of a load adjusting screw 50 against the end plate main body 30, to be engaged with the internal thread as described later. Additionally, the stopper is movable as much as 360 degrees in all the diameter directions. Consequently, the load adjusting screw 50 engaged with this internal thread is also movable along the diameter direction against the end plate 16, and is further movable as much as 360 degrees in all the diameter directions.

The internal thread 40 of each stopper 31 is engaged with the load adjusting screw 50 as described above, and each load adjusting screw 50 abuts on the protruding portion 28. The load adjusting screws have a one-to-one correspondence with the protruding portions of the spring box 27. Here, the load adjusting screw 50 on the side on which the screw abuts on the protruding portions 28 is provided, along the same axis, with a spherical recess portion (engaging portion) 51 positioned in the diameter direction of the load adjusting screw 50 so that the portion is engaged with the protruding portion 28. On a side opposite to the recess portion 51, a tool fitting portion 52 into which a tool such as a hexagonal bolt is fitted is formed along the same axis.

When these load adjusting screws 50 are rotated via the tools fitted into the tool fitting portions 52, the screws can move along the axial direction of the screws, that is, the laminating direction of the cell laminate 22 against the end plate 16. In consequence, the compressive load of the spring box 27 on the cell laminate 22 can be adjusted.

Here, during the rotation of each load adjusting screw 50, the stopper 31 is to be rotated together. However, since the rotation regulating pin portion 48 abuts on the inner wall surface of the rotation regulating hole portion 36 of the end plate main body 30, the rotation of the stopper with respect to the end plate main body 30 is regulated. When the spring box 27 applies a large load, the rotation is regulated even by friction between the bottom surface 34a of the counter hole portion 34 of the end plate main body 30 and the flange portion 42, and the load adjusting screw 50 only rotates against the end plate main body 30.

Moreover, in a state in which the compressive load of the spring box 27 is small, the load is balanced by fastening the load adjusting screw 50, so that the spherical recess portion 51 of the load adjusting screw 50 is automatically aligned with the spherical protruding portion 28 of the spring box 27 to be engaged with the recess portion. To realize this alignment, the abutment surface of the stopper 31 slides along the abutment surface of the end plate main body 30, while the stopper moves together with the load adjusting screw 50 in the diameter direction of the load adjusting screw 50.

In other words, the recess portion 51 of the load adjusting screw 50 and the protruding portion 28 of the spring box 27 engaged with each other by matching center positions with each other in the diameter direction of the load adjusting screw 50 are movable together with the stopper 31 along the diameter direction of the load adjusting screw 50 against the end plate 16.

More specifically, during assembling, in a state in which the end plate main body 30 of the end plate 16 and the spring box 27 are positioned at a positional reference (a restrictive position) X, the load adjusting screw 50 is fastened. However, even when the position of the recess portion 51 of the load adjusting screw 50 does not match that of the protruding portion 28 of the spring box 27 in the beginning owing to a manufacturing error or the like, the load adjusting screw 50 appropriately slides together with the stopper 31 with respect to the end plate main body 30. In consequence, while the end plate main body 30 and the spring box 27 are positioned, the load adjusting screw 50 is positioned with respect to the spring box 27.

If the load adjusting screw 50 is not movable in the diameter direction in this manner, the end plate and the spring box are displaced. As the case may be, a plurality of load adjusting screws cannot adequately engage with the corresponding protruding portions of the spring box. However, such phenomenon does not occur.

According to the above-mentioned first embodiment, the load adjusting screw 50 is movable along the diameter direction against the end plate 16. In consequence, the recess portion 51 of the load adjusting screw 50 and the protruding portion 28 of the spring box 27 positioned in the diameter direction of the load adjusting screw 50 so as, to be engaged with each other are movable along the diameter direction of the load adjusting screw 50 against the end plate 16. Therefore, the end plate 16 and the spring box 27 can be positioned in the diameter direction of the load adjusting screw 50, that is, the direction crossing the laminating direction of the cell laminate 22 at right angles, and assembling precision can be improved.

In addition, the end plate 16 is provided with the stopper 31 constituting a part of the end plate so that the stopper is movable in the diameter direction of the load adjusting screw 50. Therefore, the end plate 16 and the spring box 27 can be positioned with a simple structure. In addition, since the rotation of the stopper 31 is regulated with respect to the end plate 16, the stopper 31 does not follow the rotation of the load adjusting screw 50, and the load adjusting screw 50 can satisfactorily be moved along the axial direction.

Here, the rotation of the stopper 31 with respect to the end plate main body 30 may be regulated as much as 360 degrees or more. In other words, the rotation in a range less than 360 degrees can be allowed. Needless to say, the rotation in the vicinity of 360 degrees does not have to be allowed. Preferably, minimum rotation may be allowed to such an extent that the stopper 31 can slide with respect to the end plate main body 30 as described above. Furthermore, the end plate main body 30 may be provided with a rotation regulating pin portion, and the flange portion 42 of the stopper 31 may be provided with a rotation regulating hole portion into which this pin is to be inserted.

Moreover, a plurality of load adjusting screws 50 are provided, but each set of the recess portion 51 of the load adjusting screw 50 and the protruding portion 28 of the spring box 27 to be engaged with each other is individually movably provided in the diameter direction of the load adjusting screw 50 against the end plate 16. Specifically, the plurality of load adjusting screws 50 are movably provided in the diameter direction of the load adjusting screws 50 against the end plate 16, respectively. Therefore, as described above, in a state in which the end plate 16 and the spring box 27 are positioned, the load generated by the spring box 27 can be adjusted by the plurality of load adjusting screws 50.

Furthermore, the load adjusting screw 50 is provided with the recess portion 51, and the spring box 27 is provided with the protruding portion 28 to be engaged with the recess portion 51 of the load adjusting screw 50. Therefore, after the engagement, the displacement of these portions is prevented, and the load can adequately be generated by the spring box 27. Needless to say, conversely, the load adjusting screw 50 may be provided with a protruding portion, and the spring box 27 may be provided with a recess portion to be engaged with this protruding portion.

It is to be noted that in the above first embodiment, the end plate 16 is provided with the counter hole portion 34 having a diameter larger than that of the flange portion 42 of the stopper 31, and the flange portion 42 of the stopper 31 is inserted into this counter hole portion 34. However, any counter hole portion 34 may not be provided, and the flange portion 42 may be allowed to directly abut on the end plate 16.

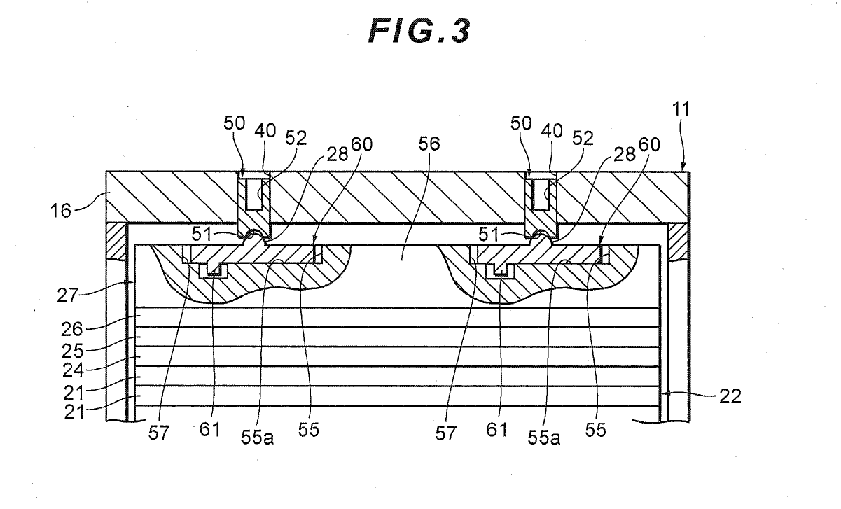

Next, a second embodiment of the fuel cell according to the present invention will be described mainly with reference to FIG. 3 in accordance with a part different from the first embodiment. It is to be noted that a part similar to the first embodiment is denoted with the same reference numerals, and the description thereof is omitted.

In the second embodiment, unlike the first embodiment, load adjusting screws 50 are not movably provided in a diameter direction thereof against an end plate 16, but the load adjusting screws 50 are movably provided in the diameter direction against a spring box 27.

That is, first, the end plate 16 is directly provided with a plurality of, specifically two internal threads 40, and the above load adjusting screws 50 are engaged with these internal threads 40, 40. It is to be noted that instead of directly forming the internal threads 40 in the end plate 16, another member may be provided with the internal thread 40, and this member may be attached so as to be immobile in the diameter direction of the internal thread 40 against the end plate 16.

On the other hand, the spring box 27 has a spring box main body 56 having such a shape that a plurality of storage recess portions 55 having the same shape are formed on the end plate 16 side of the spring box of the first embodiment. These storage recess portions 55 have a circular shape as viewed from the end plate 16 side, and bottom surfaces 55a of the portions are provided with rotation regulating hole portions 57 displaced from the centers and disposed in parallel with central axes. Each rotation regulating hole portion 57 also has a circular shape as viewed from the end plate 16 side.

Moreover, the spring box 27 has a plurality of stoppers (interposed members) 60 having the same shape and received in the storage recess portions 55. These stoppers 60 have a disc-like shape. Each stopper is provided with a protruding portion 28 in the center of the stopper on the end plate 16 side in the same manner as in the first embodiment, and on a side opposite to the protruding portion 28, a columnar rotation regulating pin portion 61 displaced from the center is formed in parallel with the center axis. A distance between the center of the stopper 60 and the center of the rotation regulating pin portion 61 is equal to a distance between the center of the storage recess portion 55 and the center of the rotation regulating hole portion 57.

In the second embodiment, the storage recess portion 55 has a diameter larger than that of the stopper 60, and the rotation regulating hole portion 57 has a diameter larger than that of the rotation regulating pin portion 61. In consequence, the stopper 60 has such play that the stopper is movable along the diameter direction of the load adjusting screw 50 against the spring box main body 56, and additionally the stopper is movable as much as 360 degrees in all the diameter directions.

Even in this second embodiment, in the same manner as in the first embodiment, during assembling, in a state in which the end plate 16 and the spring box main body 56 of the spring box 27 are positioned, the load adjusting screws 50 are fastened. However, in a state in which the compressive load of the spring box 27 is small, the load is balanced by fastening the load adjusting screws 50, so that spherical recess portions 51 of the load adjusting screws 50 are automatically aligned with spherical protruding portions 28 of the spring box 27 to be engaged with the recess portions. To realize this alignment, the stoppers 60 slide against the spring box main body 56, and move along the diameter directions of the load adjusting screws 50.

In other words, the recess portion 51 of the load adjusting screw 50 and the protruding portion 28 of the spring box 27 engaged with each other by aligning the central positions of the portions are movable together with the stopper 60 in the diameter direction of the load adjusting screw 50 against the spring box main body 56 of the spring box 27. Therefore, an effect similar to that of the first embodiment is produced.

It is to be noted that the first embodiment may be combined with the second embodiment. That is, the recess portion 51 and the protruding portion 28 of the load adjusting screw 50 and the spring box 27 positioned to be engaged with each other may movably be provided along the diameter direction of the load adjusting screw 50 against both of the end plate 16 and the spring C box 27. However, from a viewpoint of manufacturing cost or the like, the first embodiment is more preferable in which the end plate 16 is divided into the end plate main body 30 and the movable stoppers 31 and the recess portion 51 and the protruding portion 28 engaged with each other are moved against the end plate 16.

1. A fuel cell comprising: a cell laminate in which a plurality of cells are laminated; an end plate arranged outside the cell laminate in the laminating direction of the cell laminate; a load adjusting screw which moves along the laminating direction of the cell laminate against the end plate; and pressing device, arranged on the side of the end plate of the cell laminate, for adjusting a compressive load to be imparted to the cell laminate by the load adjusting screw,
wherein engaging portions of the load adjusting screw and the pressing device positioned in the diameter direction of the load adjusting screw to be engaged with each other are movably arranged in the diameter direction of the load adjusting screw against at least one of the end plate and the pressing device.

2. The fuel cell according to claim 1, further comprising:
an interposed member which is movable in the diameter direction of the load adjusting screw against at least one of the end plate and the pressing device and whose rotation is regulated as much as 360 degrees or more.

3. The fuel cell according to claim 1, wherein a plurality of load adjusting screws are provided, and engaging portions of the load adjusting screws and the pressing device are movably provided in the diameter direction of the load adjusting screws against at least one of the end plate and the pressing device.

4. The fuel cell according to claim 1, wherein the pressing device has a recess portion or a protruding portion as the engaging portion.

5. The fuel cell according to claim 1, further comprising:
an interposed member movably provided along the surface direction of the end plate against the end plate, the load adjusting screw being engaged with this interposed member.
